(19) United States
(12) Patent Application Publication
(10) Pub. No.: US 2026/0302976 A1
(43) Pub. Date: Oct. 1, 2026

(54) DIHYDROGEN TANK SYSTEM FOR AN AIRCRAFT HAVING A TURBINE

(71) Applicant: Airbus Operations SAS, TOULOUSE (FR)

(72) Inventor: Guillaume RAVENEAU, TOULOUSE (FR)

(21) Appl. No.: 19/572,079

(22) Filed: Mar. 19, 2026

(30) Foreign Application Priority Data
Mar. 28, 2025 (FR) FR2503244

(51) Int. Cl. H02P 9/00; B64D 37/28; B64D 37/30; B64D 45/00; H02P 101/25; H02P 101/30

(52) U.S. Cl. CPC H02P 9/008; B64D 37/28; B64D 37/30; B64D 45/00; H02P 2101/25; H02P 2101/30

(57) ABSTRACT

A tank system having a dihydrogen tank with inlet and outlet orifices, a supply pipe between the outlet orifice and a consumer system, a return pipe between the supply pipe and the inlet orifice, a pump between the outlet orifice and the return pipe, a control valve on the return pipe, a turbine on the return pipe upstream of the control valve, and an electric generator driven by the turbine.

### CROSS-REFERENCES TO RELATED APPLICATIONS

This application claims the benefit of French Patent Application Number FR2503244, filed on Mar. 28, 2025, the entire disclosure of which is incorporated herein by way of reference.

### FIELD OF THE INVENTION

The present invention relates to a dihydrogen tank system for an aircraft, wherein the tank system has a tank and is equipped with a turbine allowing a motive force to be generated by virtue of the dihydrogen passing into a return pipe, and to an aircraft having such a tank system.

### BACKGROUND OF THE INVENTION

In an aircraft, it is known to install dihydrogen tanks, wherein the dihydrogen serves as fuel for a consumer system, for example an engine such as a turbojet engine or a turboprop engine or a fuel cell. The dihydrogen is thus stored in a tank, where it is generally in liquid form. The dihydrogen is driven by a pump toward the consumer system. In order for the pump to function, a minimum flow rate of dihydrogen is required, but when the quantity of dihydrogen required by the consumer system is below the minimum flow rate, the excess dihydrogen is redirected downstream of the pump into a return pipe, which takes the dihydrogen back to the tank.

With such an arrangement, the hotter dihydrogen and the associated energy are thus reinjected into the tank, causing an increase in the saturation pressure in the tank.

Although such an installation is technically satisfactory, it is desirable to reduce the amount of energy that returns to the tank.

### SUMMARY OF THE INVENTION

An object of the present invention is to propose a tank system that does not have the problems of the prior art and that in particular limits the temperature increase in the tank.

To that end, a tank system for an aircraft is proposed, said tank system having:
a tank that is to contain dihydrogen and has an inlet orifice and an outlet orifice,
a supply pipe that is fluidically connected to the outlet orifice and is to supply a consumer system of the aircraft,
a turbine having an inlet and an outlet,
an electric generator having a rotor mechanically connected to rotating elements of the turbine,
a first return pipe fluidically connected between the supply pipe and the inlet of the turbine,
a pump mounted on the supply pipe between the outlet orifice and the first return pipe,
a second return pipe fluidically connected between the outlet of the turbine and the inlet orifice,
a control valve mounted on the second return pipe, and
a monitoring system having a monitoring unit, a speed sensor arranged to measure the speed of the turbine, and loading means arranged to adapt the load on the electric generator according to a target speed to be achieved for the turbine.

With such a system, the amount of energy that returns to the tank is limited owing to the decrease in temperature of the dihydrogen that returns to the tank after passing through the turbine.

Advantageously, the monitoring system has evaluation means for evaluating the flow rate at the inlet of the turbine, and command means arranged to command, alternately, an increase and a reduction in the passage cross section of the control valve according to the flow rate measured by the evaluation means and a target flow rate to be achieved.

Advantageously, the evaluation means are in the form of a flow rate sensor arranged on the first return pipe in order to measure the flow rate there.

Advantageously, when the monitoring unit detects that the measured speed of the turbine is below the target speed, the monitoring unit commands a reduction in the load on the electric generator, and when the monitoring unit detects that the measured speed of the turbine is above the target speed, the monitoring unit commands an increase in the load on the electric generator.

The invention also proposes an aircraft having a consumer system and a tank system according to one of the preceding variants, wherein the supply pipe is fluidically connected to the consumer system.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 is a side view of an aircraft according to the invention,

FIG. 2 is a schematic representation of a tank system according to the invention, and

FIG. 3 is a schematic representation of an example of hardware architecture of a monitoring unit of the aircraft.

### DETAILED DESCRIPTION OF THE PREFERRED EMBODIMENTS

FIG. 1 shows an aircraft 10 that has a tank system 100 according to the invention. The aircraft 10 here has, on either side of a fuselage 12, a wing 14 to which there is fixed an engine pylon 16 carrying an engine 50.

The tank system 100 has a tank 102, which here is housed in the fuselage 12 but which could likewise be housed in a wing 14, for example.

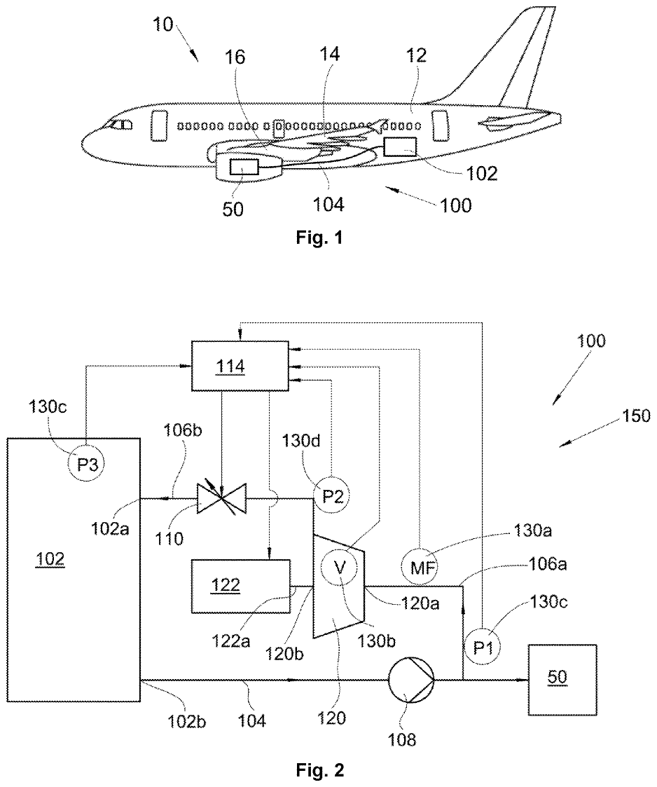

FIG. 2 shows the tank system 100 according to the invention having the tank 102, which contains dihydrogen in liquid form. The tank 102 is conventionally a closed vessel that is impervious to dihydrogen.

The tank 102 has an inlet orifice 102a and an outlet orifice 102b, wherein the inlet orifice 102a is preferably in the top portion of the tank 102 and wherein the outlet orifice 102b is preferably in the bottom portion of the tank 102.

The tank system 100 also has a supply pipe 104, which has a first end that is fluidically connected to the outlet orifice 102b and a second end that provides for the supply of dihydrogen to a consumer system of the aircraft 10, said consumer system operating by consuming dihydrogen. In the embodiment of the invention shown here, the consumer system is the engine 50 of the aircraft 10, and the second end thus opens into a combustion chamber of the engine 50 in order to operate the engine. In another embodiment of the invention, the consumer system (engine 50) may be a fuel cell, which is supplied with dihydrogen and with oxygen in order to generate electrical energy that is used by the aircraft 10.

The tank system 100 also has a turbine 120 having an inlet 120a and an outlet 120b. The tank system 100 also has an electric generator 122, which has a rotor mechanically connected to rotating elements of the turbine 120, here by way of a shaft 122a.

The tank system 100 also has a first return pipe 106a, which has a first end that is fluidically connected to the supply pipe 104 and a second end that is fluidically connected to the inlet 120a of the turbine 120, and a second return pipe 106b, which has a first end that is fluidically connected to the outlet 120b of the turbine 120 and a second end that is fluidically connected to the inlet orifice 102a of the tank 102.

In order to provide for the displacement of the dihydrogen from the tank 102 to the consumer system 50, the tank system 100 has a pump 108, which is mounted on the supply pipe 104 between the outlet orifice 102b and the first end of the first return pipe 106a.

Thus, the dihydrogen from the tank is able to go to the consumer system 50 or to the inlet orifice 102a and, for monitoring the amount of dihydrogen that returns to the tank 102, the tank system 100 has a control valve 110, in particular a flow rate control valve, which is mounted on the second return pipe 106b, that is to say downstream of the turbine 120. The control valve 110 has an adjustable passage cross section, which makes it possible to allow more or less dihydrogen to pass toward the tank 102. The passage cross section can thus be varied between a maximum cross section, corresponding to an open position of the control valve 110, and a zero cross section, corresponding to a closed position of the control valve 110.

In order to limit the amount of energy that returns to the tank 102, it is desirable for the turbine 120 to operate at a target speed that provides for a better reduction of said energy. This target speed depends, inter alia, on the technical characteristics of the turbine 120.

The tank system 100 thus has a monitoring system 150 having a monitoring unit 114, a speed sensor 130b arranged to measure the speed of the turbine 120 and connected to the monitoring unit 114 in order to send thereto data relating to the speed of the turbine 120, and loading means arranged to adapt the load on the electric generator 122 according to the target speed to be reached for the turbine 120, wherein the target speed is recorded in a memory of the monitoring unit 114.

The loading means are controlled by the monitoring unit 114. The loading means may be in the form of an alternator.

An increase in the load of the electric generator 122 consists in drawing more electrical energy from said electric generator 122, for example by connecting more electrical devices thereto. In the same way, a reduction in the load of the electric generator 122 consists in drawing less electrical energy from said electric generator 122, for example by connecting fewer electrical devices thereto.

With such an arrangement, the amount of dihydrogen returning to the tank 102 contains as little energy as possible, which limits the variations in the saturation pressure in the tank 102.

More precisely, the monitoring unit 114 has a memory in which the target speed is stored, and it has means for comparing this target speed with the speed measured and transmitted by the speed sensor 130b.

In particular, when the monitoring unit 114 detects that the speed of the turbine 120 measured by the speed sensor 130b is below the target speed, the monitoring unit 114 commands a reduction in the load on the electric generator 122, and when the monitoring unit 114 detects that the speed of the turbine 120 measured by the speed sensor 130b is above the target speed, the monitoring unit 114 commands an increase in the load on the electric generator 122.

The operating conditions of the turbine 120 are also linked to the flow rate at the inlet of the turbine 120, and it is therefore desirable to know said flow rate in order to adapt it so as to reach the nominal operating point of the turbine 120.

To that end, the monitoring system 150 has evaluation means for evaluating the flow rate at the inlet 120a of the turbine 120, and command means arranged to command, alternately, an increase and a reduction in the passage cross section of the control valve 110 according to the flow rate measured by the evaluation means and a target flow rate to be achieved.

The monitoring unit 114 has a memory in which the target speed is stored, and it has means for comparing this target speed with the flow rate measured and transmitted by the evaluation means.

According to one particular embodiment, the evaluation means are in the form of a flow rate sensor 130a arranged on the first return pipe 106a in order to measure the flow rate there.

In particular, when the monitoring unit 114 detects that the flow rate measured by the flow rate sensor 130a is below the target flow rate, the monitoring unit 114 commands an increase in the passage cross section of the control valve 110, and when the monitoring unit 114 detects that the flow rate measured by the flow rate sensor 130a is above the target speed, the monitoring unit 114 commands a reduction in the passage cross section of the control valve 110.

The means for evaluating the flow rate may have other forms. For example, they may take the form of a flow rate sensor mounted at the pump 108 and a flow rate sensor mounted at the consumer system, the difference between the two allowing the flow rate in the turbine 120 to be evaluated. For example, they may take the form of a first pressure sensor 130c mounted on the first return pipe 106a and a second sensor 130d mounted on the second return pipe 106b upstream of the control valve 110, and charts relating to the turbine 120. For example, they may take the form of the second pressure sensor 130d and a third sensor 130e disposed in the tank 102, and charts relating to the control valve 110.

The explanations above are applicable in the case where the turbine 120 accepts that the dihydrogen passing through it is in the liquid phase, the gas phase or a mixed phase.

When the turbine 120 must operate solely with single-phase dihydrogen (i.e. liquid-phase or supercritical dihydrogen), it is desirable to operate such that the dihydrogen pressure at the outlet of the turbine 120 is greater than or equal to the saturation pressure of dihydrogen.

To that end, it is possible to monitor the pressure by means of the second pressure sensor 130d, the measurement of which is compared with a target pressure value.

According to a first approach, the target pressure value is equal to 13 bar, which corresponds to the supercritical pressure of dihydrogen.

According to a second approach, the value of the target pressure is evaluated on the basis of dihydrogen saturation curves and the technical characteristics of the pump and of the turbine.

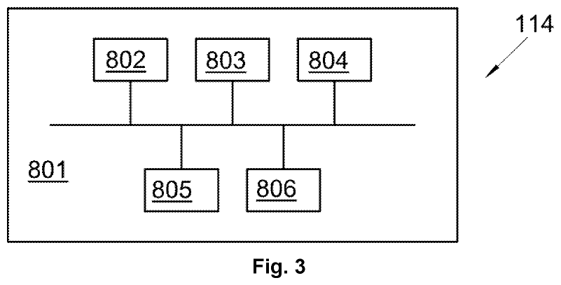

According to one particular embodiment depicted in FIG. 3, the monitoring unit 114 has, connected by a communication bus 801: a processor 802 or CPU (central processing unit); a random access memory (RAM) 803; a read-only memory (ROM) 804 or Flash memory; a storage unit 805 such as a hard disk or a storage medium reader, such as an SD (secure digital) card reader; at least one communication interface 806 allowing, for example, the monitoring unit to communicate with the valves, the pumps, the sensors, the turbine, etc.

The processor is capable of executing, upon startup, instructions loaded into the RAM from the ROM or Flash, from an external memory (not shown), from a storage medium (such as an SD card), or from a communication network. When the equipment is powered up, the processor is capable of reading instructions from the RAM and executing them. These instructions form a computer program which causes the processor to implement all or some of the algorithms and steps described above.

All or some of the algorithms and steps described above may be implemented in software form through the execution of a set of instructions by a programmable machine, for example a DSP (digital signal processor) or a microcontroller, or be implemented in hardware form by a machine or a dedicated component, for example an FPGA (field-programmable gate array) or ASIC (application-specific integrated circuit).

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A tank system for an aircraft, the tank system comprising:
a tank configured to contain dihydrogen and having an inlet orifice and an outlet orifice;
a supply pipe fluidically connected to the outlet orifice and configured to supply a consumer system of the aircraft;
a turbine having an inlet and an outlet;
an electric generator having a rotor mechanically connected to rotating elements of the turbine;
a first return pipe fluidically connected between the supply pipe and the inlet of the turbine;
a pump mounted on the supply pipe between the outlet orifice and the first return pipe;
a second return pipe fluidically connected between the outlet of the turbine and the inlet orifice;
a control valve mounted on the second return pipe; and
a monitoring system having a monitoring unit, a speed sensor arranged to measure a speed of the turbine, and a loading means configured to adapt a load on the electric generator according to a target speed to be achieved for the turbine.

2. The tank system as claimed in claim 1, wherein the monitoring system further comprises
evaluation means for evaluating a flow rate at the inlet of the turbine, and
command means configured to command, alternately, an increase and a reduction in a passage cross section of the control valve according to the flow rate and a target flow rate to be achieved.

3. The tank system as claimed in claim 2, wherein the evaluation means comprise a flow rate sensor arranged on the first return pipe in order to measure the flow rate therein.

4. The tank system as claimed in claim 1, wherein, when the monitoring unit detects that the speed of the turbine is below the target speed, the monitoring unit commands a reduction in the load on the electric generator, and when the monitoring unit detects that the speed of the turbine is above the target speed, the monitoring unit commands an increase in the load on the electric generator.

5. An aircraft comprising:
a consumer system; and
the tank system as claimed in claim 1,
wherein the supply pipe is fluidically connected to the consumer system.
